(19) United States
(12) Patent Application Publication
(10) Pub. No.: US 2026/0271964 A1
(43) Pub. Date: Sep. 17, 2026

(54) MYCOPROTEIN BASED MEAT-ANALOGUES

(71) Applicant: NOSH.BIO GMBH, Berlin (DE)

(72) Inventors: Felipe SENNE DE OLIVEIRA LINO, Berlin (DE); Tim FRONZEK, Erkner (DE)

(73) Assignee: NOSH.BIO GMBH, Berlin (DE)

(21) Appl. No.: 19/166,961

(22) PCT Filed: Mar. 19, 2024
(86) PCT No.: PCT/EP2024/057347

§ 371 Date: Sep. 19, 2025

(30) Foreign Application Priority Data
Mar. 20, 2023 (DE) 10 2023 106 906.3

(51) Int. Cl. A23J 3/20; A23J 1/00; A23J 3/22; A23J 3/32; A23L 31/00

(52) U.S. Cl. CPC A23J 3/20; A23J 1/008; A23J 3/227; A23J 3/32; A23L 31/00

(57) ABSTRACT

A food ingredient includes a water drained biomass of a first filamentous fungus as a first component having a dry matter content of 18-30 (weight/weight) %, as measured by thermogravimetric principle by measuring the start weight of a biomass sample before water draining, and drying the biomass sample by a radiant heater while measuring continuously the biomass sample weight by scales.

### BACKGROUND

Microbes are a source of potential novel sustainable food ingredients. Recently, a lot of attention has been giving on up-cycled ingredients for the food industry, as a ways to improve the economic and environmental sustainability of the food production supply chain. Spent microbial biomass is also currently being exploited as a source of food ingredients. However, so far, the focus was on upcycling readily available microbial biomass (e.g. brewer's spent yeast), which might not necessarily be the best source of functionality.

US 2022/0 117 282 A1 describes a food ingredient made by a biomass slurry which is simultaneously drained and pressed bringing the biomass material down to 60-85% water content, then shredded to granular particles in the size range of about 1 mm-about 20 mm, and sieved using 2 mm and 12 mm sieves. The, particles released through the 2 mm sieve are saved and de-hydrated separately or re-introduced to the initial slurry, whereas particles released through the 12 mm sieve but not through the 2 mm sieve are fed directly into a fluidized bed dryer for dehydration, and particles larger than 12 mm are optionally conveyed back through the shredder for further size reduction. The dehydrated particles between about 2 and about 12 mm are ready for use as a bare ingredient or to be further processed into food ingredients.

Spent filamentous fungi biomass has been shown to be a good source of food hydrocolloids or/and food applications.

We have developed a novel techno-functional ingredient from filamentous fungi biomass, which is capable of providing a wide range of functional properties, such as: thickening, binding, structuring, stabilizing, texturizing and emulsifying. Such ingredient is also rich in proteins (i.e. >25%) and dietary fibers, like chitins and beta-glucans.

### SUMMARY

The invention is defined by the appended claims.

### DETAILED DESCRIPTION

Disclosed is a food ingredient comprising a first component consisting of a water drained biomass of a first filamentous fungus having a dry matter content of 18-30 (weight/weight) %, as measured by thermogravimetric principle by measuring the start weight of a biomass sample before water draining, and drying the biomass sample by a radiant heater while measuring continuously the biomass sample weight by scales. Preferably, the first filamentous fungus has a dry matter content of 22-30 (weight/weight) %, more preferably, 25-30 (weight/weight) %, even more preferably 28-30 (weight/weight) %.

It has been surprisingly found that the fungi biomass provided a useful food ingredient, in particular, that this food ingredient can be used as a meat-analogue.

The term “food ingredient” as used herein, is an edible sub-stance which is generally not eaten alone but may be used to make food, by combination with one or more other ingredients.

Other ingredients include for example sugar, water, flavourings, fat, oil, vegetables, fruit, soya, lentils, pulses, and beans etc. A food ingredient of the present invention when combined with one or more other food ingredients may form a homogenous mixture, such that the food ingredient is not distinguishable from the other ingredients of the mixture.

Biomass generally encompasses all biological molecules comprised in the respective fungus. Water draining the biomass changes the physical properties of the biomass and makes it useful for food products.

This food ingredient, also refereed as fresh biomass can also be used as the sole ingredient, or in conjunction with a second component, an alkali treated and/or homogenized biomass of a second filamentous fungus, in meat-analogue products (e.g. burgers, schnitzels, pork and chicken strips). In the framework of this invention the term “homogenized biomass” is to be understood to be a crushed biomass, i.e., a biomass reduced to smaller pieces. By the alkali treatment and/or crushing, i.e., reducing the biomass to smaller pieces with use of a liquid for the homogenization, provides fungal cell disruption. After that alkali and/or crushing treatment, insoluble parts obtained after one or both of alkali and/or homogenization treatments are particularly useful as food ingredient.

Due to processing by alkali treatment and/or homogenization the properties of the biomass of the second component are altered to the properties characterizing the food ingredient. The alkali treated and/or homogenized biomass from fungus contains a protein content reduced by 5 to 15 wt.-% compared to the biomass of the fungus before the alkali treatment and/or homogenization, as measured by Biuret test.

The Biuret test for determining a protein content is well known. The Biuret test is a simple and rapid colorimetric test that detects the presence of proteins in a given biomass sample. It is based on the principle that copper ions in an alkaline solution form a complex with peptide bonds in proteins, which provides a violet coloration. When the so-called Biuret reagent made of sodium hydroxide (NaOH) and hydrated copper (II) sulfate is added to the biomass sample containing proteins, the copper ions react with the peptide bonds in the protein to form a violet-colored complex. The intensity of the color is proportional to the concentration of proteins in the biomass sample.

A procedure for performing the Biuret test is preferably as follows: Known amounts of freeze-dried biomass samples, especially, 0.02 to 0.04 g are weighed and placed in test tubes, distilled water is added to make up the volume to 1 ml. A volume of 3 mL of 1 M NaOH is added to each tube. The samples are then boiled for 10 min and cooled in an ice bath. Subsequently, 1 mL of 2.5% CuSO4·5H2O is added to each tube and mixed for 5 min. The samples are then transferred to 5 ml Eppendorf tubes and centrifuged (G 15000; 2 min; 20° C.). The supernatant is collected, and the absorbance is measured at a wavelength of 555 nm. Different concentrations of bovine serum albumin (BSA) are used as standards for the determination of protein in the samples. To prepare the standards a standard solution containing 45 mg of BSA/5 ml distilled water is made.

As alternative or additionally to the Biuret test, protein content can also be determined with Dumas combustion method, by which nitrogen content is determined and converted to protein content. The Dumas combustion method is an absolute method for the determination of the total nitrogen content in a usually organic matrix. A biomass sample is combusted at high temperature in an oxygen atmosphere. Via subsequent oxidation and reduction tubes, nitrogen is quantitatively converted to N₂. Other volatile combustion products are either trapped or separated. A Thermal Conductivity Detector measures the nitrogen gas, results of which are given as % or mg nitrogen, which may be converted into protein by using conversion factors. This is because the total nitrogen content is determined using the Dumas combustion method. The Dumas combustion method quantitatively recovers all forms of nitrogen, organic and inorganic, it lacks any degree of selectivity for protein. As it registers non-protein nitrogen, different correction factors are needed for different samples. Here, a protein conversion factor of 4,38 is preferably used. For the Dumas analysis around 250 mg of biomass sample are weighted.

The fungus can be a filamentous fungus.

A filamentous fungus is a fungus that grows in the form of multicellular filaments called hyphae. Also considered are fungi that can adopt a single-celled growth habit, e.g. yeasts. Filamentous fungus have been particularly useful for providing the food ingredient.

The fungus of the first and the second component can be independently selected from the group consisting of Aspergillus oryzae, Aspergillus niger, Penicillium chrysogenum, Penicillium roqueforti, Lecanicillium lecanii, Candida tropicalis, Candida utilis, Debaryomyces hansenii, Kluyveromyces marxianus, Fusarium venenatum, Rhizopus oryzae, Tremella fuciformis, Neurospora intermedia, Monascus purpureus, or a combination thereof. These filamentous fungi have been particularly useful for providing the food ingredient.

The fungus can be Aspergillus oryzae for the first and/or second component. This filamentous fungus has been particularly useful for providing the food ingredient.

In particular, the fungus can be Aspergillus oryzae MUCL 31309. This filamentous fungus has been particularly useful for providing food ingredient. This strain is publicly (and commercially) available and can be obtained, for example, from the Westerdijk Fungal Biodiversity Institute under the designation CBS 817.72.

The first component and the second component can comprise exclusively Aspergillus oryzae MUCL 31309.

The first component has a dry matter content of 18-30 (weight/weight) %, preferably 22-30 (weight/weight) %, more preferably, 25-30 (weight/weight) %, even mor preferably 28-30 (weight/weight) %. When the food ingredient does not contain the second component, i.e. contains only the first component, the food component, the food ingredient or product comprises 80-100 (weight/weight) %, 90-98, (weight/weight) %, or preferentially 95-98, (weight/weight) % of the first ingredient.

When the food ingredient does contain the second component the dry weight of the first component has a dry matter content of 18-30% (weight/weight), preferably 22-30 (weight/weight) %, more preferably, 25-30 (weight/weight) %, even mor preferably 28-30 (weight/weight) %. When the food ingredient does contain the second component the dry weight of the second component can be 1-50% (weight/weight), 1-10% (weight/weight), 1-5% (weight/weight), 1.5-3% (weight/weight), or 1.5-2.5% (weight/weight). The remainder can be water or another aqueous solution. When the food ingredient does contain the second component, i.e. contains the first component and the second component, the food ingredient or product comprises 80-100 (weight/weight) %, 90-98, (weight/weight) %, or preferentially 95-98, (weight/weight) % of the combined first and second component. When the food ingredient does contain the second component, i.e. contains the first component and the second component, the food ingredient or product comprises, the first component and the second in a ratio of 70:30 to 30:70, or 60:40 to 40:60, or preferentially 55:45 to 45:55, or 50:50.

The first component can be obtainable by a method comprising the following steps in sequence:
Provide a harvested biomass of a fungus;
Drain the harvested biomass of a fungus to reduce the water content at room temperature (to remove excess moisture),
optionally mix the first component with additional ingredients and incubate in dry air at 180° C. to 220° C. for 1-5 minutes, 1-3 minutes, or 1-2 minutes.

Draining can be performed using filter, decanters or/and centrifuges.

The second component can be obtainable by a method comprising the following steps in sequence:
Provide a harvested biomass of a fungus;
Add an alkali solution to the harvested culture to provide a first composition; and/or Homogenize the first composition to provide a second composition;
Incubate the first and/or second composition for at least 0.5 hours to provide a third composition;
Separate the insoluble part of the third composition from the soluble part;
Wash the insoluble part in an aqueous solution;
Reduce the moisture content of the washed insoluble part and thereby provide the second component of the food ingredient.

Above method steps have been particularly useful for obtaining the claimed second component. The method for obtaining the second component is explained further below.

Disclosed is also a food product comprising the food ingredient.

The food product or food ingredient can comprise 2 to 20% (weight/weight), 4 to 40% (weight/weight) or 5 to 50 (weight/weight) of the dry weight first component.

The food product of food ingredient can comprise in addition to the first component 0.1%-10.0% (weight/weight), 0.1%-2.0% (weight/weight), 0.2-1.0% (weight/weight), 0.3-0, 95% (weight/weight), or 0.4-0.6% (weight/weight) of the dry weight second component.

The food product may comprise the above-described food ingredient and other food ingredients, flavours, and stabilizers.

The food product may be a meat-analogue product.

Depending on the dry weight ratio of the first and second component a variety of different textures can be achieved. Moreover, by adapting the water content of the food product or food ingredient the texture of the food product or food ingredient a variety of different textures can be provided

Disclosed is a method for providing the second component of a food ingredient comprising the following steps in sequence:
Provide a biomass of a fungus;
Add a alkaline solution to the biomass to provide a first composition; and/or Homogenize the first composition to provide a second composition;
Incubate the first and/or second composition for at least 0.5 hours to provide a third composition;
Separate the insoluble part of the third composition from the soluble part;
Wash the insoluble part in an aqueous solution;
Reduce the moisture content of the washed insoluble part and thereby provide the second component of the food ingredient.

The biomass can be a harvested biomass of fungus.

A harvested biomass is a biomass of fungus or simply fungus that has been grown to a predefined density and subsequently separated from any media or other components attaching to the outside of the fungus. This means the harvested biomass only contains the fungus itself, i.e. the biomass of the fungus.

The alkali solution has a pH of 9-14 or 10-14.

The alkali solution can be an aqueous solution of an inorganic compound. For example the alkali solution can comprise alkaline metal or alkaline earth metal hydroxides, for examples, NaOH, KOH, Mg(OH) 2. The alkali solution alternatively can comprise phosphates (PO43−), carbonates (CO32−), or sulfides.

The alkali solution can comprise 0.01-5 M, 0,05-1 M, or 0.075-1.25 M, or 0.9-1.1 M of the inorganic compound (for example NaOH).

50-150 ml, 75-125 ml, 90-110 ml of the alkaline solution can be added per 1 gram dry matter of the biomass to provide the first composition.

The dry matter content (DM) can be obtained by using a moisture analyzer (e.g., equipped with a halogen lamp). For example, Kern DAB 200-2 Feuchtebestimmer (KERN & SOHN GmbH, Balingen-Frommern, Deutschland) can be used. The dry matter content is measured by thermogravimetric principle by measuring the start weight of a biomass sample before water draining, and drying the biomass sample by a radiant heater while measuring continuously the biomass sample weight by scales.

Homogenization can be carried out using a kitchen blender at the highest speed for 0.5 to 1.5 or 0.8 to 1.2, or 0.9 to 1.1 minutes. Homogenization can also be performed using any blending/homogenization device which result in cells and cell walls of the fungus being disrupted. The homogenization is performed by using a solution such as the alkali solution or water.

The homogenization step has the function of disrupting the mycelial structure through shear stress. Thus, the homogenization can be considered to be a mycelial disruption step. By the homogenization step, the biomass is crushed, i.e. reduced to smaller particles.

The obtained first and/or second composition can be incubated for at 0.5 to 5, 0.5 to 4, 0.5 to 3, 0.5 to 2, 0.75 to 1.25, 0.9 to 1.1 hours.

This step yields an insoluble and a soluble part.

The insoluble part can be separated from the soluble part to provide the third composition, for example, by filtration, centrifugation or any other known separation technique.

For example, the filtration for isolating the insoluble part can be performed using a filter with a mesh size of 30-150 micrometer, 50-100 micrometer, 60-90 micrometer, or 65-85 micrometer.

The insoluble part can be washed once or at least two times with an aqueous solution. The aqueous solution can be water or a buffer in the range of pH 6.5 to 7.5.

The washing can be performed with an inline or batch procedure. The amount/volume of aqueous solution can be twice the volume of the amount/volume of the alkaline solution.

The washing step can comprise adding the aqueous washing solution to the insoluble part, mixing (thoroughly) the washing solution and the insoluble part, and separating the in-soluble part from the aqueous washing solution. This washing step can be performed one time, two times, three time, four times, or five times.

The insoluble part can be separated from the soluble part, for example, by filtration, centrifugation or any other known separation technique.

For example, the filtration for isolating the insoluble part can be performed using a filter with a mesh size of 30-150 micrometer, 50-100 micrometer, 60-90 micrometer, or 65-85 micrometer.

The moisture content can be reduced by filtering, like filter pressing, continuous vacuum belt filter, or a rotary pressure filter.

These filtering methods allow to reduce the moisture of the food ingredient without negatively affecting its desired properties.

The above-described method can further comprise a method for providing the biomass of the fungus to be used in the above-described method comprising the following steps in sequence:
Grow the fungus by aerobic fermentation in a medium comprising a carbon source;
Harvest the fungus by separating the fungus from the medium to provide the biomass of the fungus.

The carbohydrate source can be selected from the group of sugar beet molasses, potato waste, in particular, potato peelings, potato fibre, concentrated potato fruit juice, potato starch from potato protein isolation production, or any other plant starch from a plant source, apple pomace, cider pomace, sugar beet pulp, sugarcane molasses, malt extract or brewer's spent grain.

These carbohydrate sources have the advantage that they are produced as by-products in food industry processes and inexpensive. Thus, the method allows to reuse by-products.

The aerobic fermentation can be a submerged fermentation. The growth conditions depend on the respective fungus. The fermentation can be performed at 20-30, 22-28, or 24-26° C. The fermentation can be performed for 3-15, 4-10, or 5-7 days.

The fungus can be harvested by centrifuging, decanting or filtering. The harvesting step serves to separate the fungus from the medium to provide the biomass of the fungus. The filtering method can be filter pressing, continuous vacuum belt filter, or a rotary pressure filter method.

### EXAMPLES

If not otherwise indicated all %-values are (weight/weight).

### Example 1: Identification of Fungi of Interest and Production Of Biomass

It is known that collagen-like and collagen associated domains are widespread through eukaryotes. Such genetic makeup might confer superior performance for the functional ingredients produced from such species.

The fungi can comprise genes coding for proteins having a hydrocolloid functionality, in particular, genes coding for collagen-like or collagen associated domains. Proteins comprising collagen-like or collagen associated domains and organisms expressing such collagen-like or collagen associated domains are suitable candidates for proteins having a hydrocolloid functionality.

To produce the biomass the genomes of fungi were screened on DNA level in publicly available data bases for the presence of collagen-like domains on their genome (eg. screened from the supplemental material from Linden, T. A., & King, N. (2021). Widespread distribution of collagens and collagen-associated domains in eukaryotes. BioRxiv, 1-31. https://doi.org/10.1101/2021.10.08.463732).

Aspergillus oryzae, Aspergillus niger, Penicillium chrysogenum, Penicillium roqueforti, Lecanicillium lecanii, Candida tropicalis, Candida utilis, Debaryomyces hansenii, Kluyveromyces marxianus, Fusarium venenatum, Rhizopus oryzae, Tremella fuciformis, Neurospora intermedia, and Monascus purpureus were identified as fungi containing collagen-like domains.

In particular, Aspergillus oryzae has been identified as a species of interest due to the potential collagen-like domain on its genome.

For the experiments, Aspergillus oryzae MUCL 31309 was used.

The strain MUCL 313019 is a strain isolated from food production processes (koji for sake making), therefore safe to consume and possibly scalable. Any other strain comprising collagen-like or collagen associated domains is expected to also exhibit the desired properties for the methods and products of this disclosure

A biomass of Aspergillus oryzae MUCL 31309 was produced via an aerobic submerged fermentation (ca. 25° C. for 6 days) using an inexpensive carbon source (malt extract). After the fungi completely consumes the carbon source the biomass is harvested via a cheese cloth (however any other filtering process is applicable).

In particular, a seed culture is started by inoculating fresh media (either molasses or malt extract, at a concentration of 2% total reducing sugars (TRS) with a loopful of spores from a petri dish, under sterile conditions. This seed culture is later incubated under agitation (100 rpm) at 25° C. for 2 days. This seed culture is later used to inoculate 5 L glass vessels, with a pitch rate (v/v) between 1-58. The fermentation is performed statically, with sparged sterile compressed air, which is fed to the fermenter with the support of a pump. The temperature is maintained around 25° C. The aeration provides enough agitation to keep the mycelia in suspension and a good mixing of the media. After 4-6 days, the fermentation is finished and the biomass is harvested by filtration. After dewatering through vigorous pressing of the biomass through the cheese cloth used for filtration it can be stored under refrigeration (8° C.) for 1 week, or for longer periods if frozen (−20° C.). Alternatively it can be processed directly through the downstream processing, which is described below.

### Example 2: Production of First Component Food Ingredient

The fungi biomass is harvested from the fermentation using a cheese cloth. After separating the biomass from the broth, the biomass is squeezed and pressed, by twisting the cheese cloth, in order to remove as much excess water from the biomass as possible. The final biomass has a DM content of 18-30%.

### Example 3: Production of Second Component Food Ingredient

### Experimental Example

The dry matter content of the harvested biomass was determined
100 mL 0.1 M NaOH/g dry weight of biomass were added (100 mL of a 0.1 M NaOH solution are added for every g of dry matter of the biomass, which was previously assessed via a moisture analyzer)
A kitchen blender was used at the highest speed for 1 minute to homogenize the biomass (Rheological data from this sample indicates that it shows a viscoelastic solid material behavior in amplitude sweep analyses. The measured linear viscoelastic range value from this material indicates that it is harder and more difficult to deform when compared to carboxyl methyl cellulose (CMC) solutions (2%), and also have a more elastic behavior com-pared to CMC. In temperature sweep analysis, it is shown that although not producing a real gel, the product has a gel like structure that is stable to temperatures between 20 and 90° C., with a hardness similar to a gel produced with egg white (10%))
The biomass was left at room temperature for 1 hour.
The residual insoluble biomass was separated from the soluble reside via filtration using a 75 micrometer mesh filter (cheese cloth filter)
The insoluble was washed twice with approximately same amount of water as the volume of added alkaline. The washing process included resuspending the insoluble biomass and homogenizing shortly via kitchen blender, and separating via the same filtration (75 micrometer mesh size).

To reduce moisture content the biomass was subjected to filter pressing (which filter press device). Finally the dry matter content was measured and determined.

### Comparative Examples

In comparative example 1 no NaOH was added, but replaced with water. All other steps remained the same.

In comparative example 2 no homogenizing step was carried out. Each homogenizing step was replaced with a mixing step, wherein the biomass was shaken with the respective solutions by hand. All other steps remained the same.

### Example 4: Production of Meat Analogs of Chicken Nuggets

To evaluate the capability of the produced food ingredient of only the first component to replace food ingredients of animal origin chicken nuggets were prepared using the following protocol.

### Ingredients.

0.5 kg of A. oryzae biomass, pressed and drained of liquid. (the dry matter content of this material is 20-25 (w/w) 8)

### Marinade.

¼ cup light soy sauce+1 tablespoon, of liquid aminos or tamari (any is fine).
½ cup filtered water.
1 teaspoon garlic powder.
1 teaspoon onion powder.
1 teaspoon smoked paprika

### Batter.

¾ cup of milk, or ANY vegan milk.
1½ teaspoons apple cider vinegar, or regular vinegar.
1 cup gluten free flour, or regular flour

### Crumb Mixture.

1¼ cup gluten free breadcrumbs, or regular breadcrumbs.
3 teaspoons smoked paprika
3 teaspoons nutritional yeast
1 teaspoon garlic powder
1 teaspoon onion powder
1 teaspoon Italian seasoning
1 teaspoon sea salt
¼ cup of oil, if pan-frying, if not, instructions for baking are below

### Production Method

1. Take the biomass and slice it in half length wise (so you end up with two large slices the same length and width as the original). Tear the biomass into 2.5 cm cubes.
2. In a bowl or glass tupperware, add all the marinade ingredients and stir to combine. Add in the biomass and stir to combine so all the biomass is coated. Marinade for at least 15 minutes, but up to overnight.

### Batter & Crumb Mixture

1. In a bowl, add the milk and the apple cider vinegar. Stir to combine and let sit for about 2 minutes. This is your buttermilk mixture.
2. Add the flour to its own bowl and line up side by side.
3. In a bowl add all the crumb mixture ingredients. Line up in a bowl beside the buttermilk.

### Final Mixture

Take one biomass piece from the marinade. Dip it into the flour, shaking off all the excess flour, then into the buttermilk. Shake off the excess buttermilk, then dip it back into the flour, then into the buttermilk again, shaking off all the excess again. Then dip it into the crumb mixture, roll around, and place on a baking sheet.

### Cooking the Biomass

Heat ¼ cup of oil in a baking over medium high heat. When oil is hot, add one piece of biomass. Cook for 1½ minutes on each side (check for browning) or until golden brown, then flip and cook for another 1½ minutes on the other side. Remove to a paper towel to absorb the excess oil.

To BAKE these: Preheat the oven to 200° C. Line the battered and breaded biomass pieces on the baking sheet and spray with some cooking oil on both sides. Bake for 25 minutes, flipping once way at the halfway mark.

The obtained chicken nuggets have a dry matter content of about 35 (w/w) %.

Taste and texture were tested against commercial benchmarks (2 versions of chicken and 2 versions of plant-based nuggets from the supermarket), in a tasting panel of 10 experienced food testers and found to be closer regarding taste and texture to the taste and texture of chicken nuggets than available plant-based nuggets.

### Example 5: Production of Other Meat Analogs

This functional biomass (second component) can be mixed with fresh biomass (first component) in different ratios. One example is the production of burger patties with different moisture and texture profiles, performed as follows:
Add 1:1 biomass (12-18% DW) and functional biomass (FB, 2% mass in water suspension)
Mix briefly via rod gently and thoroughly distribute the FB mater in the biomass;
Take 50 g mixture out;
Squeeze about 30 g water out, the residual patty has texture analogue to schnitzel;
Squeeze about 20 g water out, the residual patty has texture analogue to juice burger patty.

Taste and texture were tested against commercial benchmarks (2 versions of chicken and 2 versions of plant-based patties from the supermarket), in a tasting panel of 10 experienced food testers and found to be closer regarding taste and texture to the taste and texture of chicken nuggets than available plant-based nuggets.

1. Food ingredient comprising a water drained biomass of a first filamentous fungus as a first component having a dry matter content of 18-30 (weight/weight) %, as measured by thermogravimetric principle by measuring the start weight of a biomass sample before water draining, and drying the biomass sample by a radiant heater while measuring continuously the biomass sample weight by scales, wherein the first filamentous fungus is selected from the group consisting of Aspergillus oryzae, Aspergillus niger, Penicillium chrysogenum, Penicillium roqueforti, Lecanicillium lecanii, Candida tropicalis, Candida utilis, Debaryomyces hansenii, Kluyveromyces marxianus, Fusarium venenatum, Tremella fuciformis, Neurospora intermedia, or Monascus purpureus, which are fungi containing collagen-like domains.

2. The food ingredient of claim 1, further comprising as a second component an alkali treated and/or homogenized biomass of a second filamentous fungus, the alkali treated and/or homogenized biomass from fungus containing a protein content reduced by 5 to 15 wt.-% compared to the biomass of the fungus before the alkali treatment and/or homogenization, as measured by Biuret test.

3. The food ingredient of claim 2, wherein the second filamentous fungus is selected from the group consisting of Aspergillus oryzae, Aspergillus niger, Penicillium chrysogenum, Penicillium roqueforti, Lecanicillium lecanii, Candida tropicalis, Candida utilis, Debaryomyces hansenii, Kluyveromyces marxianus, Fusarium venenatum, Rhizopus oryzae, Tremel-la fuciformis, Neurospora intermedia, or Monascus purpureus.

4. The food ingredient of claim 1 further comprising as a second component an alkali treated and/or homogenized biomass of a second filamentous fungus, the alkali treated and/or homogenized biomass from fungus containing a protein content reduced by 5 to 15 wt.-% compared to the biomass of the fungus before the alkali treatment and/or homogenization, as measured by Biuret test, wherein the first and/or the second filamentous fungus is Aspergillus oryzae, preferentially Aspergillus oryzae MUCL 31309.

5. The food ingredient of claim 2 further comprising as a second component an alkali treated and/or homogenized biomass of a second filamentous fungus, the alkali treated and/or homogenized biomass from fungus containing a protein content reduced by 5 to 15 wt.-% compared to the biomass of the fungus before the alkali treatment and/or homogenization, as measured by Biuret test, wherein the first and the second fungus are the same.

6. The food ingredient of claim 2, wherein the second component is obtainable by a method comprising the following steps in sequence:
Provide a biomass of the second filamentous fungus;
Add an alkaline solution to the biomass to provide a first composition; and/or Homogenize the first composition to provide a second composition;
Incubate the first and/or second composition for at least 0.5 hours to provide a third composition;
Separate the insoluble part of the third composition from the soluble part;
Wash the insoluble part in an aqueous solution;
Reduce the moisture content of the washed insoluble part and thereby provide an alkali treated and/or homogenized biomass of a second filamentous fungus.

7. Food product comprising the food ingredient of claim 1.

8. Food product according to claim 7, wherein the food product is a meat-analogue product.

9. A method for providing a food ingredient comprising the following steps in sequence:
Provide a harvested biomass of a second filamentous fungus;
Add an alkaline solution to the harvested biomass to provide a first composition; and
Homogenize the first composition to provide a second composition;
Incubate the second composition for at least 0.5 hours to provide a third composition;
Separate the insoluble part off the third composition from the soluble part;
Wash the insoluble part in an aqueous solution;
Reduce the moisture content of the washed insoluble part and thereby provide an alkali treated and homogenized biomass of a second filamentous fungus;
Add a water drained biomass of a first filamentous fungus to thereby provide the food ingredient,
wherein the first filamentous fungus is selected from the group consisting of Aspergillus oryae, Aspergilus niger, Penicillium chryogemon, Pencillium roqueforti, Lecanicillium lacanii, Candida tropicalis, Candida utilis, Debaryomyces hansenil, Khyveromyces marxlanus, Fusariuth venenalium, Tremella fuciformis, Neurospora intermedia, or Monascus purpureus, which are fungi containing collagen-like domains.

10. The method of claim 9, further comprising reducing the water content of the obtained food ingredient until a predetermined amount of liquid is removed.

11. The method of claim 10, wherein the alkaline solution has a pH of 10-14.

12. The method of claim 9, wherein the 75-125 ml of the alkaline solution are added per 1 gram dry matter of the biomass to provide the first composition.

13. The method of claim 9, wherein the in-soluble part is washed at least two times in the aqueous solution and/or and the aqueous solution is water.

14. The method of claim 9, wherein the moisture content is reduced by filter pressing.

15. The method of claim 9, further comprising a method for providing the harvested biomass of the second fungus comprising the following steps in sequence:
Growing the second filamentous fungus by aerobic fermentation in a medium comprising a carbon source;
Harvesting the second filamentous fungus by separating the fungus from the medium to provide the biomass of the fungus.

16. The method of claim 15, wherein the second filamentous fungus is harvested by filtering, decantation, or centrifugating the fungus from the medium to provide the biomass of the fungus.
